(19) United States
(12) Patent Application Publication
(10) Pub. No.: US 2007/0295458 A1
(43) Pub. Date: Dec. 27, 2007

(54) Transferring Apparatus for Brittle Member

(75) Inventor: Takeshi Akechi, Tokyo (JP)

Correspondence Address: NORRIS, MCLAUGHLIN & MARCUS, P.A., 875 THIRD AVE, 18TH FLOOR, NEW YORK, NY, 10022, US

(73) Assignee: LINTEC CORPORATION, Tokyo (JP)

(21) Appl. No.: 11/573,661

(22) PCT Filed: May 25, 2005
(86) PCT No.: PCT/JP05/09567

§ 371 Date: Jun. 27, 2007

(30) Foreign Application Priority Data
Aug. 17, 2004 (JP) 2004 237332

(51) Int. Cl. B32B 38/10

(52) U.S. Cl. 156/510; 156/536

(57) ABSTRACT

A transferring apparatus for a brittle member capable of peeling a hard member from the brittle member without applying a stress more than required to the brittle member and effectively preventing the brittle member from being damaged by erroneous peeling is provided. When the hard member is peeled off from a stuck structure formed by sticking the brittle member on the top surface of the hard member through a double-sided adhesive sheet to transfer the brittle member onto the adhesive sheet, the adhesive sheet is stuck on the brittle member of the stuck structure to form it integrally with a frame, the hard member side is positioned and fixed onto a table (8), and the frame (6) is raised diagonally upward with respect to the surface of the table with a predetermined torque by a torque control motor (12) with a rotary shaft (13) as a fulcrum. The hard member is peeled off from the brittle member with a force for raising the frame, namely, with the predetermined torque. When the hard member is peeled off, the peeling action is confirmed by peeling confirmation means (37) formed by two reflection type sensors (38-1, 38-2).

### TECHNICAL FIELD

The present invention relates to a transferring apparatus for a brittle member, which is used when the brittle member, for example, a semiconductor wafer is processed to be extremely thin in the state in which it is stuck onto a hard member, for example, glass, thereafter, the hard member is peeled off from the brittle member, and the brittle member is transferred to an adhesive sheet such as a dicing sheet.

### BACKGROUND ART

Conventionally, as a transferring apparatus for a brittle member of this kind, for example, the one with the structure disclosed in, for example, Patent Document 1 is known. The transferring apparatus of this document peels off a hard member 2 from a peeling target object 1 shown in FIG. 11, that is, what is integrated with a frame 6 by sticking an adhesive sheet such as a dicing sheet 7 onto a brittle member 4 of a stuck structure 5 constituted of the hard member 2, and the brittle member 4 which is stuck to its top surface through a double-sided adhesive sheet 3, and transfers the brittle member 4 to the adhesive sheet.

As the transferring method, the transferring and boning apparatus of this document adopts the method in which when the frame 6 is raised diagonally upward with respect to the surface of the table by using a cam mechanism after the hard member 2 of the peeling target object 1 is positioned and fixed to a table, the hard member 2 is peeled off from the brittle member 4 and the brittle member 4 is transferred to the adhesive sheet such as the dicing sheet 7.

However, it is found out that since according to the conventional transferring apparatus as described above, the structure which raises the frame 6 with only the simple cam mechanism is adopted, the force which raises the frame 6 is not constant, and a stress more than required is sometimes applied to the brittle member 4, thus making it impossible to peel the brittle member 4 naturally.

Further, it is found out that according to the conventional transferring apparatus, it is not known whether peeling of the hard member 2 is started normally or not, and as a result that the frame 6 is to rise in spite of occurrence of erroneous peeling, an unnatural force is applied to the brittle member 4, thus causing the fear of occurrence of breakage and the like of the brittle member 4 due to erroneous peeling.

Patent Document 1: Japanese Patent Publication [Laid-Open] No. 2003-338534

### DISCLOSURE OF THE INVENTION

The present invention is made to solve the problems, and has an object to provide a transferring apparatus for a brittle member capable of peeling off a hard member without applying a stress more than required to the brittle member, and capable of effectively preventing the brittle member from being damaged by erroneous peeling.

In order to attain the object, the present invention is, in a apparatus which peels off a hard member from a brittle member to transfer the brittle member onto an adhesive sheet by sticking the adhesive sheet on the brittle member of a stuck structure constituted of the hard member and the brittle member stuck to its top surface to form it integrally with a frame, thereafter, positioning and fixing the hard member onto a table, and raising the frame diagonally upward with respect to a surface of the table, characterized by having peeling starting point forming means which forms a starting point of peeling between the hard member and the brittle member, peeling confirmation means which confirms peeling of the hard member from the starting point formed by the peeling starting point forming means, and frame drive means which raises whole of the frame diagonally upward with respect to the table surface with a predetermined torque while peeling is confirmed with the peeling confirmation means.

In the present invention, the frame drive means raises the entire frame diagonally upward with respect to the table surface with the predetermined torque, and the hard member is peeled off from the brittle member with the force which raises the frame, namely, with the predetermined torque. On this occasion, peeling is confirmed with the peeling confirmation means.

In the present invention, the peeling confirmation means can adopt the construction including a first sensor that detects initial peeling of the hard member which starts from the starting point.

In the present invention, the peeling confirmation means may be constructed to further include a second sensor that detects completion of peeling of the hard member.

The frame drive means is constituted of a torque controllable motor of which output torque is controlled to be equal to a set torque, a rotary shaft connected to an output shaft of the torque controllable motor, and a pair of support arms which are fixed to the rotary shaft and support the frame, and can adopt a structure in which the torque controllable motor operates, the rotary shaft rotationally operates at a predetermined angle, and thereby, both the support arms rise diagonally upward with respect to the surface of the table with the rotary shaft as the fulcrum.

In the present invention, the peeling starting point forming means may be constituted of a cutter which slides to and enters into between the hard member and the brittle member.

In the present invention, the brittle member may be stuck to the top surface of the hard member via a double-sided adhesive sheet. In this case, the peeling starting point forming means includes a cutter provided slidably toward an adhesive layer on the hard member side [out] of both adhesive layers of the double-sided adhesive sheet, and can have a structure in which a cutting edge of the cutter enters into an inside by a predetermined depth from an outer periphery of the adhesive layer on the hard member side to form a starting point of peeling.

When the structure of the peeling starting point forming means as described above is adopted, the cutting edge of the cutter smoothly enters into the inside of the adhesive layer on the hard member side to form the starting point of peeling, and therefore, the advantage of decreasing erroneous formation of the starting point and the like is provided.

In the present invention, the peeling starting point forming means may include detecting means which detects that the cutter does not enter into a predetermined position.

### EFFECT OF THE INVENTION

The present invention provides the following working-effects [operational effects].

(1) Since the frame drive means can raise the entire frame diagonally upward with respect to the surface of the table with a predetermined torque, and the hard member is peeled off from the brittle member with the force that raises the frame, namely, with the predetermined torque, a stress more than required can be effectively prevented from being applied to the brittle member, and the hard member can be peeled off naturally.

(2) Since peeling is confirmed with the peeling confirmation means when the hard member is peeled off, breakage or the like of the brittle member by erroneous peeling can be effectively prevented.

### BEST MODE FOR CARRYING OUT THE INVENTION

A best mode for carrying out the present invention will now be described with reference to the attached drawings.

FIG. 1 is a schematic perspective view of an entire transferring apparatus for a brittle member which is one embodiment of the present invention, FIG. 2 is a schematic perspective view of the transferring apparatus in FIG. 1 during a peeling operation, FIG. 3 is an enlarged perspective view of peeling starting point forming means which constitutes the transferring apparatus in FIG. 1, FIG. 4 is a sectional view of the transferring apparatus on line A-A in FIG. 1, FIG. 5 is a sectional view of the transferring apparatus on line A-A in FIG. 2, FIG. 6 is a sectional view of the transferring apparatus on line B-B in FIG. 1, and FIG. 11 is a sectional view of a peeling target object (stuck structure integrated with a frame through a dicing sheet 7) which is set at a transferring and boding apparatus and the like in FIG. 1.

First, the peeling target object which is used in this embodiment will be briefly described. The peeling target object has a stuck structure 5 which is constituted of a hard member 2 (glass plate) and a brittle member 4 (semiconductor wafer) which is stuck onto its top surface through a double-sided adhesive tape 3, and has a structure in which a dicing sheet 7 (adhesive sheet) is stuck onto the brittle member 4 of the stuck structure 5 to form it integrally with a frame 6 (hereinafter called “peeling target object 1”) as shown in FIG. 11. Of both adhesive layers 3a and 3b of the double-sided adhesive sheet 3, an adhesive which is curable [by ultraviolet rays] and significantly reduceable in adhesion with ultraviolet rays is used for the adhesive layer 3a on the hard member side, and an adhesive with weak adhesion is used for the adhesive layer 3b on the brittle member side. For the hard member 2, a transparent glass plate in the substantially same shape as the brittle member 4 is adopted, and for the brittle member 4, a semiconductor wafer which is ground to an extremely thin thickness in the state in which it is stuck to the hard member 2 is adopted. It should be noted that in this embodiment, the dicing sheet 7 is used as an adhesive sheet, but sheets other than the dicing sheet can be used as the adhesive sheet.

A transferring apparatus M of this embodiment is an apparatus which peels the hard member 2 (glass plate) from the brittle member 4 (semiconductor wafer) of the peeling target object 1 to transfer the brittle member 4 (semiconductor wafer) to the dicing sheet 7.

As such a transferring method, the transferring apparatus M of this embodiment adopts a method in which the hard member 2 is positioned and fixed onto a table 8 and the entire frame 6 is raised diagonally upward with respect to the surface of the table 8 is adopted for the peeling target object 1 as described above. The transferring apparatus M of this embodiment which adopts this method is concretely constructed as follows.

The transferring apparatus M of this embodiment includes the table 8 as means for positioning and fixing the hard member 2 as shown in FIGS. 1 and 2. The table 8 has a flat front surface, a recessed part 9 is formed on the surface of the table 8, and the recessed part 9 becomes an opening 9a at one end side of the table 8. A plurality of vacuum holes 10 are formed on a bottom surface of the recessed part 9 (see FIG. 6), and these vacuum holes 10 are connected to a negative pressure generator not shown via a hose or the like so as to be able to suck and fix the hard member 2 onto the front surface of the recessed part 9. In this embodiment, a circular glass plate is used as the hard member 2, and therefore, the structure in which a plurality of vacuum holes 10 are annularly disposed in accordance with the circular shape of the hard member is adopted, but the other disposition structure of the vacuum holes 10 other than this may be adopted.

The depth from the surface of the table 8 to the bottom surface of the recessed part 9 is set in accordance with the thickness of the hard member 2. In concrete, it is set so that the top surface of the hard member 2 is flush with the front surface of the table 8 when the hard member 2 of the peeling target object 1 shown in FIG. 11 is sucked and fixed to the bottom surface of the recessed part 9 (see FIG. 8(a)).

The transferring apparatus M of this embodiment includes frame drive means 11 as means for raising the frame 6 diagonally upward with respect to the surface of the table 8 with a predetermined torque. The frame drive means 11 is constructed by a torque controllable motor 12, a rotary shaft 13, a pair of support arms 14 and the like in concrete.

The torque controllable motor 12 (hereinafter called “the torque control motor 12”) is a motor which can be controlled so that the torque set in advance is outputted, and is disposed laterally behind the table 8 via a motor support base not shown (see FIG. 1).

The rotary shaft 13 is provided behind the table 8, and is disposed parallel with the surface of the table 8. The rotary shaft 13 has its one end 13a connected to an output shaft of the torque control motor 12 via a coupling 15. The rotary shaft 13 is supported rotatably around its axis via a known bearing not shown.

A pair of arms (14-1) and (14-2) have their arm rear ends 14a and 14a fixed to the rotary shaft 13 respectively at arm rear ends 14a and 14a, and are provided to be parallel with each other to support the frame 6 from its undersurface side. In this embodiment, the structure in which step portions 16 are formed on inner top surfaces of the support arms 14, and linear portions 6a formed at two spots on the outer periphery of the frame 6 are mounted on both the step portions 16 as shown in FIG. 6 is adopted.

In order to prevent falling off of the frame 6 from a pair of support arms 14, this embodiment adopts the structure in which opposite sides of the arm rear ends 14a of a pair of support arms 14 are connected with a connecting bar 17, clamp means 18 is provided at both sides of the connecting bar 17 so as to grip the frame 6 with the clamp means 18 to fix it as shown in FIG. 2.

When the rotary shaft 13 rotationally operates around its axis by the operation of the torque control motor 12, a pair of support arms 14 are raised diagonally upward with respect to the surface of the table 8 with the rotary shaft 13 as a fulcrum as shown in FIG. 2. Accordingly, the frame 6 which is mounted on a pair of support arms 14 is also integrally raised in the same direction. On this occasion, the frame 6 is raised in accordance with a predetermined torque, that is, the output torque of the torque control motor 12. The predetermined torque differs in accordance with the thickness, shape, size and the like of the brittle member 4, and it can be optionally set by an operator. Peeling may be performed by changing the output torque of the torque control motor by dividing it into an initial peeling stage, an intermediate peeling stage, a final peeling stage and the like.

Further, the transferring apparatus M of this embodiment includes means for forming a starting point of peeling (peeling starting point forming means 19) between the hard member 2 and the brittle member 4 in the state in which the hard member 2 of the peeling target object 1 is sucked and fixed onto the bottom surface of the recessed part 9 of the table 8.

The peeling starting point forming means 19 includes a cutter 20 which is slidably provided toward an interface between the hard member and the adhesive layer 3a of both the adhesive layers 3a and 3b of the double-sided adhesive sheet 3 interposed between the hard member 2 and the brittle member 4, and the cutting edge of the cutter 20 enters from the outer periphery of the adhesive layer 3a at the hard member 2 side into the inside by a predetermined depth to form a starting point of peeling (see the part shown by the reference numeral 40 in FIG. 9).

The cutter 20 is located at the side of the front surface 8a of the table 8, disposed to be opposed to the rotary shaft 13 behind the table, and is slidingly driven from that position via cutter sliding drive means 21 which will be described later. On this occasion, the cutter 20 slidingly moves to slide on the table 8 while inclining at a predetermined angle with respect to the surface of the table 8 to reach the interface of the hard member 2 and the adhesive layer 3a (see FIG. 8(b)).

As shown in FIG. 3, the cutter sliding drive means 21 has the structure in which a cutter position fine adjusting unit 25 is stacked on a slider 23 of a slide unit 22 via a linear rail 24, and the cutter 20 is mounted on a cutter mounting base 26 provided at a top portion of the cutter position fine adjusting unit 25.

The slider 23 of the slider unit 22 is constructed to be slidable in the longitudinal direction with respect to the front surface of the table 8 by a known ball screw mechanism or the like.

The linear rail 24 is provided between a slide base plate 27 mounted on the slider 23 and a unit installation plate 28 mounted on the undersurface of the cutter position fine adjusting unit 25 so that the slider 23 side and the cutter position fine adjusting unit 25 side become movable in the direction of an axis Y. The cutter sliding drive means 21 in this embodiment is constructed so that a pin 33 provided at the slide base plate 27 and a pin 32 provided at the unit installation plate 28 are connected to pull each other by a tension spring 31, and a protruding piece 29 provided at the unit installation plate 28 abuts on a locking part 30 mounted on the slide base plate 27 to stand still.

In the cutting sliding drive means 21 constituted of the structure as described above, when the slider 23 is caused to advance in the direction of the front surface 8a of the table 8 by operation of the slide unit 22, all the components on the linear rail 24 (the cutter 20, the cutter position fine adjusting unit 25, the unit installation plate 28, and the like) usually follow the slider 23 and advance in the same direction at the same speed as the slider 23 in the state in which the locking part 30 on the slide base plate 27 side and the protruding piece 29 on the unit installation plate 28 side abut on each other by the action of the tension spring 31.

In the case of the apparatus M, the interface of the adhesive layer 3a on the hard member side, of the double-sided adhesive sheet 3 located on the hard member 2, and the hard member 2 is set to be flush with the surface of the table 8, when the hard member 2 is sucked and fixed to the bottom surface of the recessed part 9 of the table 8. Therefore, usually, the upper portion of the hard member 2 does not protrude upward from the surface of the table 8. However, occurrence of variation to the thickness of the hard member 2 is not avoided, and when the variation in the thickness of the hard member 2 is large, the upper side of the hard member 2 sometimes protrudes upward from the surface of the table 8 (see FIG. 12(a)). In this case, if the construction in which the cutter 20 advances to slide on the table 8 and approaches the adhesive layer 3a on the hard member side is adopted, the cutter 20 collides against the protruded part of the hard member 2 and is caught by it. If the slider 23 keeps advancing in such a state as shown in FIG. 12(b), the components on the lower side from the linear rail 24, namely, only the slide base plate 27 and the slider 23 continue to advance against the action of the tension spring 31, and all the components on the linear rail 24, namely, the unit installation plate 28, the cutter position fine adjusting unit 25 and the cutter 20 stop on the spot and do not follow the slide operation of the slider 23. Such a condition similarly occurs when the thickness of the hard member 2 is smaller than the depth of the recessed part 9, and the cutter 20 is caught by the double-sided adhesive sheet 3, or the brittle member 4 and does not follow the slide operation of the slider 23.

Thus, the cutter sliding drive means 21 is provided with abnormality detecting means 34. The abnormality detecting means 34 is means for detecting an abnormal operation of only the components on the lower side from the linear rail 24 continuing to advance against the operation of the tension spring 31 as described above, that is, the fact that the cutter 20 does not enter into the predetermined position (the interface between the hard member 2 and the adhesive layer 3a).

Such abnormality detecting means 34 includes a sensor 35 which is constituted by disposing a light emitting element 35-1 and a light receiving element 35-2 which receives light beams from the light emitting element 35-1 with a fixed gap between them, and a light shielding plate 36 for shielding an optical path from the light emitting element 35-1 to the light receiving element 35-2.

The sensor 35 of the abnormality detecting means 34 is mounted on the slide base plate 27, and the light emitting element 35-1 and the light receiving element 35-2 which constitute the sensor 35 are disposed to be arranged side by side on the line orthogonal to the slide direction of the slide base plate 27. The light shielding plate 36 is mounted on the unit installation plate 28 side, and is disposed in front of a gap G1 of the light emitting element 35-1 and light receiving element 35-2, and the light shielding plate 36 does not shield the optical path of the sensor in the normal operation and is in the ON state. However, when only the slide base plate 27 advances by the abnormal operation as described above, the gap G1 between the light emitting element 35-1 and the light receiving element 35-2 is shielded by the light shielding plate 36, and the sensor output of the sensor 35 is brought into the OFF state from the ON state to detect abnormality.

The cutter position fine adjusting unit 25 is provided with four knobs 25a to 25d. These four knobs 25a to 25d are means for performing fine adjustment of the position and the inclination angle of the cutter 20 mounted on the cutter mounting base 26. For example, when the three knobs 25a to 25c are individually operated respectively, fine adjustment of the position of the cutter 20 can be performed individually in the three axial directions of X, Y and Z. When the remaining one knob 25d is operated, fine adjustment of the inclined angle of the cutter 20 with respect to the surface of the table 8 can be performed. Known means are applied to the mechanism which performs fine adjustment of the position and the inclination angle of the cutter 20 by the operation of the knobs 25a to 25d of this kind, and therefore, the detailed description of the mechanism will be omitted.

The transferring apparatus M of this embodiment has means for confirming peeling of the brittle member 4 from the starting point formed with the cutter 20 (peeling confirmation means 37). As shown in FIG. 4, the peeling confirmation means 37 includes two reflection type sensors 38-1 and 38-2 as the first and the second sensors, and they are individually accommodated in recesses 39 provided in the bottom surface of the recessed part 9 of the table 8. The reflection type sensor 38-1 on one side (hereinafter called “a first reflection type sensor”) is disposed in the vicinity of the region where the starting point is made, more specifically, at the front surface 8a side on the table 8 where the cutter 20 approaches, in order to detect the initial peeling of the hard member 2, which starts from the starting point formed with the cutter 20. The other reflection type sensor 38-2 (hereinafter called “second reflection type sensor”) is disposed in the vicinity of the region where peeling of the hard member 2 is completed, more specifically, near the rotary shaft 13 on the table 8 to detect peeling completion of the hard member 2.

The first and the second reflection type sensors 38-1 and 38-2 are both constituted of known limited reflection type sensors having light projecting/receiving elements, and monitor the distance by receiving light beams transmitted through the hard member 2 and reflected at the brittle member 4.

Here, the frame 6 supported by a pair of support arms 14 is to rise diagonally upward with respect to the surface of the table 8 with the rotary shaft 13 as the fulcrum with a predetermined output torque of the torque control motor 12. When the hard member 2 starts to be normally peeled off, the first reflection type sensor 38-1 is brought into the OFF state from the ON state and determines that it is normally peeled off. Thus, when the sensor output of the first reflection type sensor 38-1 is not switched to the OFF state from the ON state even after a predetermined time lapses from the start of the operation of raising the frame 6 diagonally upward by the operation of the torque control motor 12, it can be confirmed that the initial peeling mistake of the hard member 2 occurs.

The above description is the description of the peeling detection method of the hard member 2 by the first reflection type sensor 38-1, and the second reflection type sensor 38-2 is constructed to detect peeling completion of the hard member 2 by the same method as the first reflection type sensor 38-1.

Next, an operation of the transferring apparatus M of this embodiment which is constructed as described above will be described in detail based on FIGS. 7 to 10.

In the transferring apparatus M of this embodiment, when the hard member 2 is peeled from the stuck structure 5 as shown in FIG. 11, the dicing sheet 7 is stuck to the brittle member 4 of the stuck structure 5 to form it integrally with the frame 6 first as shown in FIG. 11, as the preparatory operation. This is the peeling target object 1 to the transferring apparatus M.

In the peeling target object 1, the adhesive layer 3a on the hard member side, of the double-sided adhesive sheet 3 is cured by ultraviolet rays irradiation from the hard member 2 (transparent glass plate) side in advance, and thus its adhesive strength is significantly reduced.

Next, as shown in FIG. 7(a), the peeling target object 1 is placed so that the hard member 2 of the peeling target object 1 enters into the recessed part 9 of the table 8. On this occasion, the frame 6 part of the peeling target object 1 is placed on a pair of support arms 14 which are horizontal, and by sliding the peeling target object 1 in the arrow direction in this state, the arc portion of the hard member 2 abuts on the inner wall surface of the arc portion of the recessed part 9 as shown in FIG. 7(b), whereby the peeling target object 1 is positioned and set in the fixed position on the table 8. The operation up to this may be manually performed, but may be automated by an articulated robot or the like.

When the positioning and setting operation is completed, the operation of sucking the hard member 2 side of the stuck structure 5 through the vacuum holes 10 from the bottom surface of the recessed part 9 is performed. By the suction operation, as shown in FIG. 8(a), the entire stuck structure 5 descends toward the bottom surface side of the recessed part 9, the dicing sheet 7 bends corresponding to this, and the hard member 2 of the stuck structure 5 is sucked and fixed to contact closely to the bottom surface of the recessed part 9. Thereby, the interface between the adhesive layer 3a on the hard member side, of the double-sided adhesive sheet 3, which is located on the hard member 2, and the hard member 2 becomes flush with the surface of the table 8.

When the suction and fixing operation as described above is completed, the operation of forming the starting point of peeling of the hard member 2 is performed next. Namely, the torque control motor 12 is operated, and with the rotary shaft 13 as the fulcrum, a pair of support arms 14 slightly rise diagonally upward as shown in FIG. 8(b). Thereby, a very small gap G2 into which the cutter 20 can enter is formed at the lower side of the connection bar 17 which connects tip end sides of a pair of support arms 14. Then, the slider 23 of the slide unit 22 is caused to slidingly advance toward the front surface 8a of the table 8, and the cutter 20 advances from the front surface 8a side of the table 8 and enters into the gap G2.

The cutter 20 which enters into the gap G2 further advances to go toward the interface between the adhesive layer 3a on the hard member side, of the double-sided adhesive sheet 3 and the hard member 2. At this time, the cutter 20 slidingly moves in such a manner as to slide on the table 8 while inclines at a predetermined angle with respect to the surface of the table 8. The cutting edge of the cutter 20 enters into the inside by a predetermined depth from the outer periphery of the adhesive layer 3a on the hard member side. Thereby, the starting point 40 of peeling which is constituted of cut of the cutter 20 as shown in FIG. 10 is formed on the outer periphery of the adhesive layer 3a on the hard member side. After formation of the starting point of peeling, the slider 23 of the slide unit 22 is slidingly retreated, and the cutter 20 is returned to the original position.

When the starting point 40 of peeling by the cutter 20 is formed as described above, peeling and transferring operation is performed next. Namely, a pair of support arms 14 are further raised diagonally upward with the rotary shaft 13 as the fulcrum as shown in FIG. 9(b), and thereby, with the hard member 2 of the stuck structure 5 kept sucked and fixed to the table 8, the brittle member 4 of the stuck structure 5 is raised diagonally upward together with the frame 6 and the dicing sheet 7 with a pair of support arms 14, whereby peeling of the hard member 2 from the starting point 40 of peeling is started.

Peeling of the hard member 2 is widened like ripples as shown by the broken lines in FIG. 10 by the support arm 14 further rising upward. When peeling of the hard member 2 advances to the farthest position from the starting point 40 of peeling finally, the brittle member 4 of the stuck structure 5 rises diagonally upward together with the frame 6 and the dicing sheet 7 with the support arm 14 also above the second reflection type sensor 38-2. Therefore, sensor output of the second reflection type sensor 38-2 is switched to OFF from ON, and by monitoring switching of the sensor output, completion of peeling of the hard member 2 is confirmed. The brittle member 4 which is completely peeled like this is separated from the hard member 2 and is transferred in such a manner as to remain on the dicing sheet 7 side.

The brittle member 4 (semiconductor wafer) which is transferred to the dicing sheet 7 as described above is diced thereafter to be chips. Known apparatuses are applied to the dicing apparatus, the apparatus which picks up the chips after dicing from the dicing sheet, and the like.

Incidentally, it is assumed that even when the starting point 40 of peeling is formed with the cutter 20 as described above, peeling of the hard member 2 does not start from the starting point 40 and erroneous peeling occurs. For example, when adhesive strength of the adhesive layer 3a does not reduce to the desired value due to poor irradiation of ultraviolet rays to the adhesive layer 3a on the hard member side, of the double-sided adhesive sheet 3, or when the abnormality detecting means 34 does not detect abnormality though the cutter 20 of the peeling starting point forming means 19 enters into the interface of the brittle member 4 and the adhesive layer 3b on the brittle member side, or the like, erroneous peeling is likely to occur. When erroneous peeling occurs, a stress more than required is applied to and accumulated on a semiconductor wafer or the like that is the brittle member, and therefore, it is desirable to detect erroneous peeling as quickly as possible.

In the transferring apparatus M of this embodiment, as the means which finds and detects erroneous peeling as described above early, sensor output from the first reflection type sensor 38-1 is used. Namely, the sensor output from the first reflection type sensor 38-1 is outputted to the control part not shown of the apparatus M.

The control part of the apparatus M monitors the sensor output from the first reflection type sensor 38-1, counts operation time of the torque control motor 12, and controls the operation of the torque control motor 12 based on these data.

Namely, when the sensor output from the first reflection type sensor 38-1 is not switched to OFF from ON even after predetermined time elapses from the start of the operation of raising the frame 6 diagonally upward by the operation of the torque control motor 12, it is determined that erroneous initial peeling of the hard member 2 from the starting point 40 occurs as described above, and the peeling operation is not continued any more. Thus, the control part of the apparatus M outputs the instruction to stop the operation to the torque control motor 12 to temporarily stop the raising operation of the frame 6. Thereby, the torque control motor 12 stops, and the raising operation of the frame 6 is temporarily intermitted.

Thereafter, in order to carry out the raising operation of the frame 6 again, the control part of the apparatus M outputs the instruction to restart the operation to the torque control motor 12. Thereby, the torque control motor 12 is restarted, and the raising operation of the frame 6 is carried out again.

When the sensor output from the first reflection type sensor 38-1 is not switched to OFF from ON and erroneous initial peeling from the starting point 40 still occurs even if the operation of carrying out the raising operation again as described above is repeated, the measures such as stopping transferring processing, informing an operator by a buzzer, lighting a lamp and the like may be taken in order to protect the brittle member 4.

Upon success in initial peeling of the brittle member 4, the sensor output of the first reflection type sensor 38-1 is switched to OFF from ON, and when the sensor output of the second reflection type sensor 38-2 is not switched to OFF from ON after predetermined time elapses from the point of time at which it is switched to OFF, peeling of the brittle member 4 is not completed, and any erroneous peeling occurs after success in the initial peeling. In this case, the control part of the apparatus M can take the measures before the brittle member is damaged by stopping the peeling operation, and informing the operator by a buzzer, lighting of a lamp or the like as described above.

In the transferring apparatus M of this embodiment, the torque control motor 12 of the frame drive means 11 raises the entire frame 6 diagonally upward with respect to the surface of the table 8 with a predetermined torque, and the hard member 2 is peeled off from the brittle member 4 with the rising force of the frame 6, namely, the predetermined torque. Therefore, a stress more than required can be effectively prevented from being applied to the brittle member 4, and the hard member can be peeled off naturally.

According to the transferring apparatus M of this embodiment, on the occasion of peeling the hard member 2, confirmation of the peeling is performed by the peeling confirmation means 37, and therefore, breakage or the like of the brittle member 4 due to erroneous peeling can be effectively prevented.

### BRIEF DESCRIPTION OF THE DRAWINGS

FIG. 1 is a schematic perspective view of an entire transferring apparatus for a brittle member, which is one embodiment of the present invention;

FIG. 2 is a schematic perspective view of the transferring apparatus in FIG. 1 during a peeling operation;

FIG. 3 is an enlarged perspective view of peeling starting point forming means which constitutes the transferring apparatus in FIG. 1;

FIG. 4 is a sectional view of the transferring apparatus on line A-A in FIG. 1;

FIG. 5 is a sectional view of the transferring apparatus on line A-A in FIG. 2;

FIG. 6 is a sectional view of the transferring apparatus on line B-B in FIG. 1;

FIG. 7 is an explanatory view of a positioning and mounting operation to the transferring apparatus in FIG. 1, (a) is an explanatory view of the state in which a peeling target object in FIG. 11 is disposed on a table, and (b) is an explanatory view of the state in which the peeling target object disposed as in (a) is positioned and mounted;

FIG. 8 is an explanatory view of an operation of the transferring apparatus in FIG. 1, (a) is an explanatory view of the state in which the hard member side of the stuck structure is sucked and fixed to the recessed part bottom surface, and (b) is an explanatory view of the state in which a cutter slidingly moves in such a manner as to slide on a table while inclining at a predetermined angle with respect to the surface of the table, and the state in which the cutter forms a starting point of peeling;

FIG. 9 is an explanatory view of an operation of the transferring apparatus in FIG. 1, (a) is an explanatory view of the starting point of peeling formed by the cutter, and (b) is an explanatory view of an initial peeling stage of the brittle member starting from the starting point of peeling;

FIG. 10 is an explanatory view of an advance state of peeling;

FIG. 11 is a sectional view of the peeling target object (stuck structure which is integrated with the frame through the dicing sheet) which is set at the transferring apparatus and the like in FIG. 1; and

FIG. 12 is an explanatory view of an operation of the peeling starting point forming means in FIG. 3, (a) is an explanatory view of the state in which the upper side of the hard member protrudes upward from the surface of the table, and (b) is an explanatory view of the operation when a slider continues to advance in the state of (a).

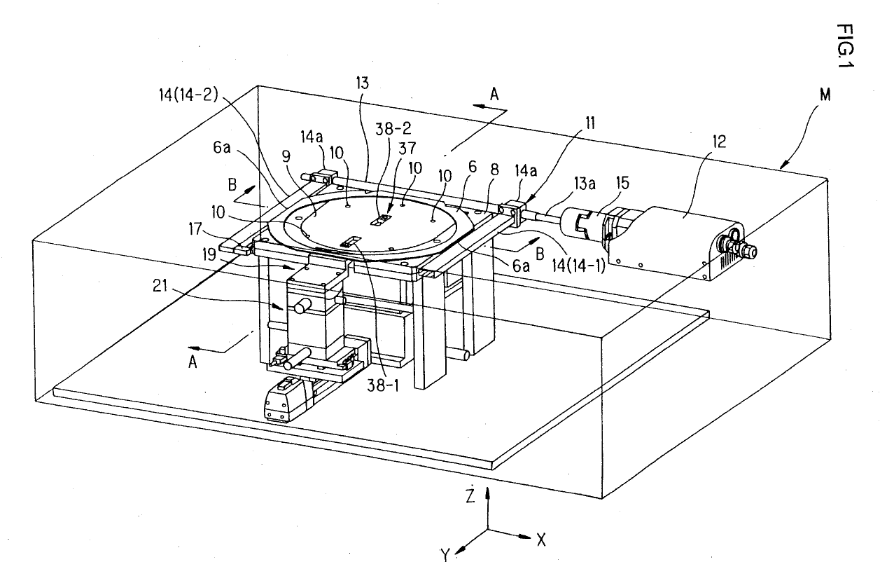

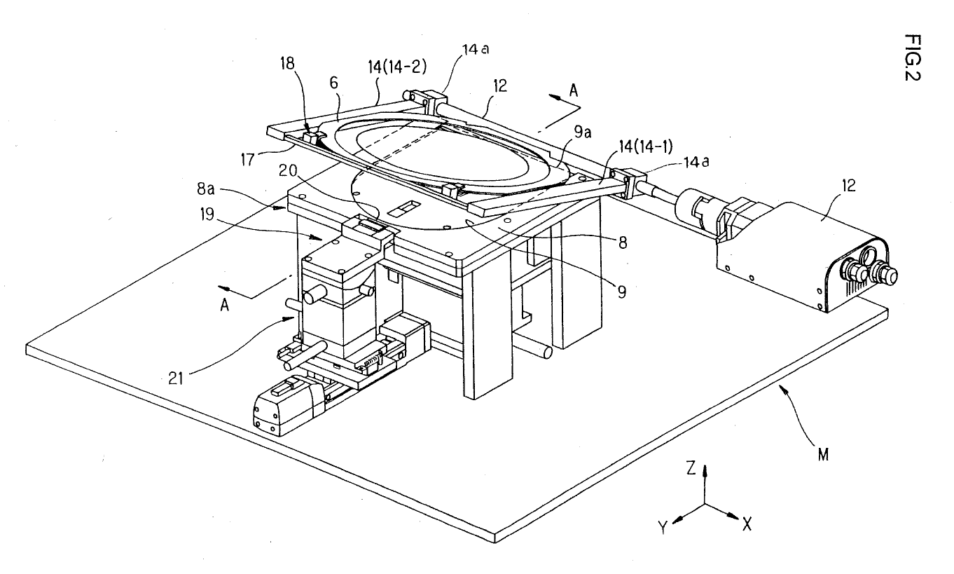

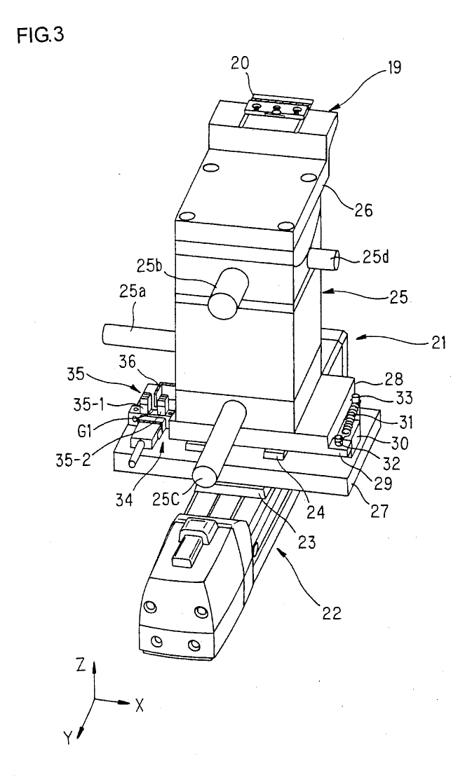

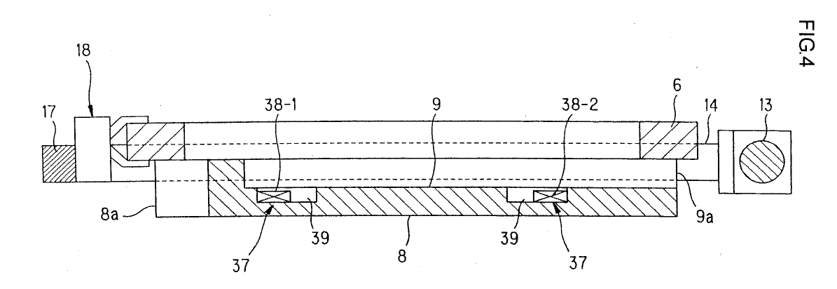

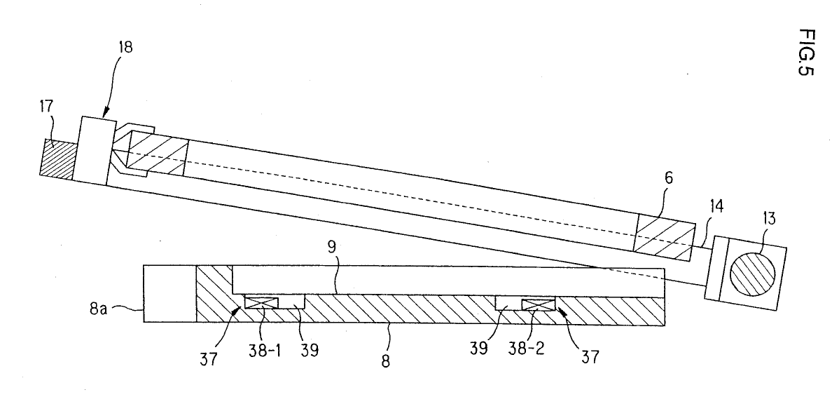

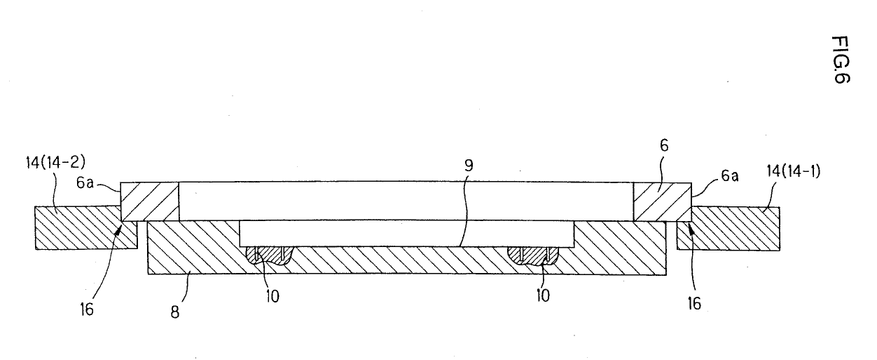

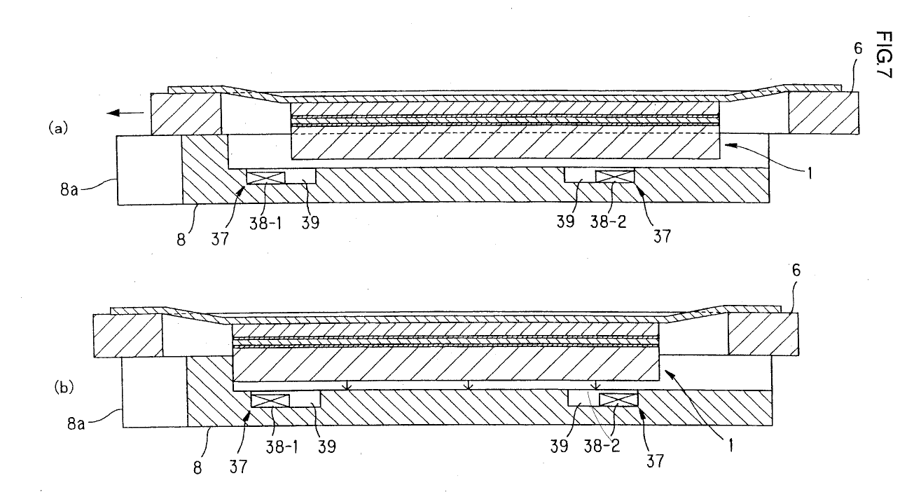

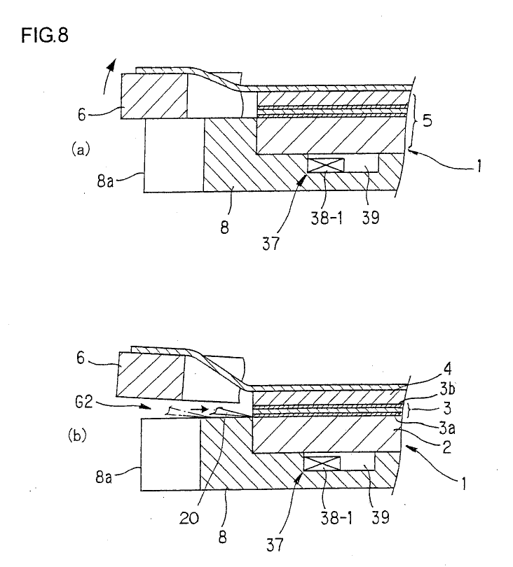

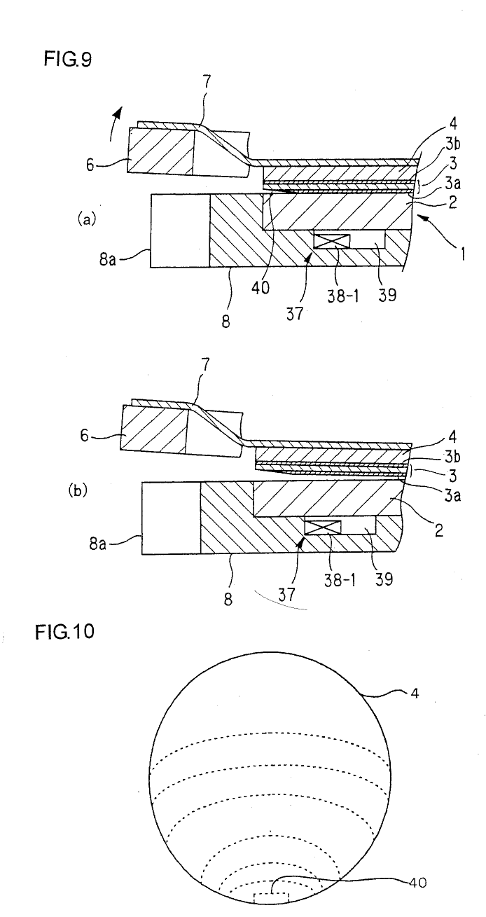

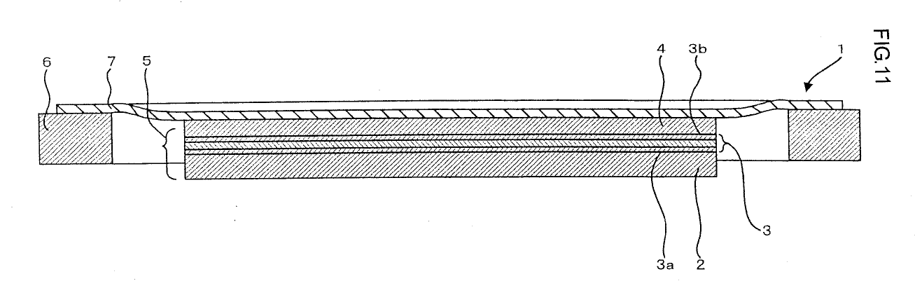

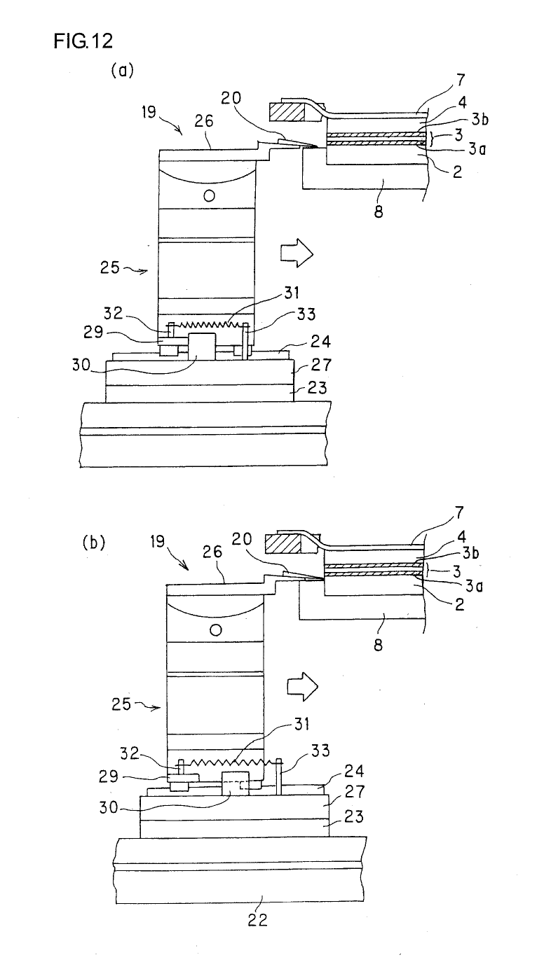

### DESCRIPTION OF SYMBOLS

1 peeling target object
2 hard member
3 double-sided adhesive sheet
3a hard member side adhesive layer
3b brittle member side adhesive layer
4 brittle member
5 stuck structure
6 frame
7 dicing sheet (adhesive sheet)
8 table
8a front side of table
9 recessed part
10 vacuum hole
11 frame drive means
12 torque controllable motor
13 rotary shaft
14 a pair of support arms
15 coupling
16 step portion
17 connecting bar
18 clamp means
19 peeling starting point forming means
20 cutter
21 cutter sliding drive means
22 slide unit
23 slider
24 linear rail
25 cutter position fine adjusting unit
25a to 25d knobs
26 cutter mounting base
27 slide base plate
28 unit installation plate
29 protruding piece
30 locking part
31 tension spring
32 pin on protruded piece
33 pin on slide base plate
34 abnormality detecting means
35 sensor
35-1 light emitting element
35-2 light receiving element
36 light shielding plate
37 peeling confirmation means
38-1 first reflection type sensor (first sensor)
38-2 second reflection type sensor (second sensor)
39 recess
40 starting point of peeling

1. A transferring apparatus for a brittle member, which peels off a hard member from a brittle member to transfer said brittle member onto an adhesive sheet by sticking the adhesive sheet on the brittle member of a stuck structure constituted of the hard member and the brittle member stuck to its top surface to form it integrally with a frame, thereafter, positioning and fixing said hard member onto a table, and raising said frame diagonally upward with respect to a surface of said table, [characterized by] comprising:
peeling starting point forming means which forms a starting point of peeling between said hard member and said brittle member;
peeling confirmation means which confirms peeling of said hard member from said starting point formed by said peeling starting point forming means; and
frame drive means which raises whole of said frame diagonally upward with respect to said table surface with a predetermined torque while peeling is confirmed with said peeling confirmation means.

2. The transferring apparatus for a brittle member according to claim 1, characterized in that
said peeling confirmation means comprises a first sensor that detects initial peeling of said hard member, which starts from said starting point.

3. The transferring apparatus for a brittle member according to claim 2, characterized in that
said peeling confirmation means further comprises a second sensor that detects completion of peeling of said hard member.

4. The transferring apparatus for a brittle member according to claim 1, characterized in that
said frame drive means comprises
a torque controllable motor of which output torque is controlled to be equal to a set torque,
a rotary shaft connected to an output shaft of the torque controllable motor, and
a pair of support arms which are fixed to the rotary shaft and support said frame, and has
a structure in which said torque controllable motor operates, said rotary shaft rotationally operates at a predetermined angle, and thereby, said both support arms rise diagonally upward with respect to the surface of said table with said rotary shaft as the fulcrum.

5. The transferring apparatus for a brittle member according to claim 1, characterized in that
said peeling starting point forming means comprises a cutter which slides to and enters into between said hard member and said brittle member.

6. The transferring apparatus for a brittle member according to claim 1, characterized in that
said brittle member is stuck to the top surface of said hard member via a double-sided adhesive sheet, and
said peeling starting point forming means comprises a cutter provided slidably toward an adhesive layer on the hard member of both adhesive layers of said double-sided adhesive sheet, and has a structure in which a cutting edge of the cutter enters into an inside by a predetermined depth from an outer periphery of the adhesive layer on said hard member to form a starting point of peeling.

7. The transferring apparatus for a brittle member according to of claims 5, characterized in that
said peeling starting point forming means has detecting means which detects that said cutter does not enter into a predetermined position.

8. The transferring apparatus for a brittle member according to claim 6, characterized in that
said peeling starting point forming means has detecting means which detects that said cutter does not enter into a predetermined position.
